(19) United States
(12) Patent Application Publication
(10) Pub. No.: US 2012/0025655 A1
(43) Pub. Date: Feb. 2, 2012

(54) MOTOR ROTOR AND MOTOR HAVING THE MOTOR ROTOR

(75) Inventors: Shih-Jen Yang, Taipei (TW); Chen-Chia Yang, Taipei (TW); Chung-En CHEN, Taipei (TW)

(73) Assignee: SYSTEM GENERAL CORPORATION, Taipei (TW)

(21) Appl. No.: 12/846,097

(22) Filed: Jul. 29, 2010

(51) Int. Cl. H02K 21/22

(52) U.S. Cl. 310/156.38

(57) ABSTRACT

A motor rotor includes an annular body and a magnetic body installed on an inner lateral surface of the annular body. The magnetic body has a first curved surface and a second curved surface opposing the first curved surface. The magnetic body props against the inner lateral surface of the annular body via the first curved surface. The first curved surface has a first curvature less than a second curvature of the second curved surface. Because the magnetic body of the motor rotor has an uneven thickness, and an air gap interval formed between the motor rotor and the stator also has an uneven width, forces applied to a region where the magnetic forces change directions are smooth. Therefore, the vibration of the whole motor is reduced, and the noises are suppressed effectively.

### BACKGROUND OF THE INVENTION

1. Field of the Invention

This invention relates to motor rotors, and particularly, to a motor rotor that an air gap between the motor rotor and a stator is uneven, and a motor having the motor rotor.

2. Description of Related Art

In modern society, motors have been applied to a variety of products. In general, a motor forms an inductive magnetic field by using currents. The inductive magnetic field interacts with an inner permanent magnet to generate a rotational movement. In addition to providing the rotational movement, the motor may also output rotational mechanical energy that may be converted into a linear movement or vibrating movement by certain mechanisms.

FIG. 1A (PRIOR ART) is an oblique view of an outer rotor motor of the prior art. The outer rotor motor comprises a stator 11 installed in a central region and a rotor 12 surrounding an outer periphery of the stator 11. The stator 11 is a stationary part. The stator 11 comprises a field coil 111, and generates a magnetic field by inputting currents into the field coil 111. The rotor 12 includes an annular body 121 and a plurality of permanent magnets 122 installed on an inner lateral surface of the annular body 121. The permanent magnets 122 provides another magnetic field. The rotor 12 generates a rotational movement according to an interaction of the two magnetic fields.

FIG. 1B (PRIOR ART) is a top view of the outer rotor motor shown in FIG. 1A (PRIOR ART). As shown in the figure, each of the permanent magnets 122 has a first curved surface 122a fastened to the inner lateral surface of the annular body 121 and a second curved surface 122b opposing the first curved surface 122a. The second curved surface 122b faces the stator 11, and the first curved surface 122a is parallel to the second curved surface 122b.

However, the permanent magnets of the motor rotor of the prior art have the same thickness, and the magnetic fields generated by the permanent magnets for the stator are average. Accordingly, the action forces (cogging torques) applied to a region where the magnetic forces change direction when the rotor is rotating cause the motor to vibrate and make noises, and affect the operation quality of the motor.

Therefore, how to solve the drawbacks of the prior art to reduce the noises generated by an operating motor is becoming one of the most urgent issues in the art.

### SUMMARY OF THE INVENTION

In view of the above-mentioned drawbacks of the prior art, the present invention provides a motor rotor including an annular body having an inner lateral surface and a magnetic body installed on the inner lateral surface of the annular body, the magnetic body having a first curved surface with a first curvature fastened to the inner lateral surface of the annular body and a second curved surface with a second curvature opposing the first curved surface, wherein the second curvature greater than the first curvature.

The magnetic body of the motor rotor of an embodiment according to the present invention is fastened to the inner lateral surface of the annular body by a locking, a riveting or an adhering technique.

In the motor rotor of an embodiment of according to the present invention, the annular body is a sheet metal part.

According to the motor rotor of an embodiment, the annular body comprises non-magnetoconductive metal or plastic, and the non-magnetoconductive metal is one selected from the group consisting of aluminum, copper, zinc, tantalum and stainless steel.

In the motor rotor of the embodiment according to the present invention, the magnetic body is a permanent magnet.

The present invention further provides a motor, comprising a stator and a motor rotor surrounding an outer periphery of the stator, the motor rotor comprising an annular body having an inner lateral surface, and a magnetic body installed on the inner lateral surface of the annular body, the magnetic body having a first curved surface with a first curvature fastened to the inner lateral surface of the annular body and a second curved surface with a second curvature opposing the first curved surface, wherein the second curvature is different to the first curvature.

Compared with the prior art, the magnetic body of the motor rotor of the present invention has an uneven thickness, and an air gap between the motor rotor and a stator thus has an uneven width, resulting in the decrease of cogging torques and the decrease of the vibration generated by the motor when the magnetic forces change direction. Therefore, the noises generated by an operating motor is reduced.

### BRIEF DESCRIPTION OF DRAWINGS

The invention can be more fully understood by reading the following detailed description of the preferred embodiments, with reference made to the accompanying drawings, wherein:

FIG. 1A (PRIOR ART) is an oblique view of an outer rotor motor of the prior art;

FIG. 1B (PRIOR ART) is a top view of the outer rotor motor shown in FIG. 1A (PRIOR ART); and

FIG. 2 is a planar view of a motor rotor and its corresponding stator of an embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

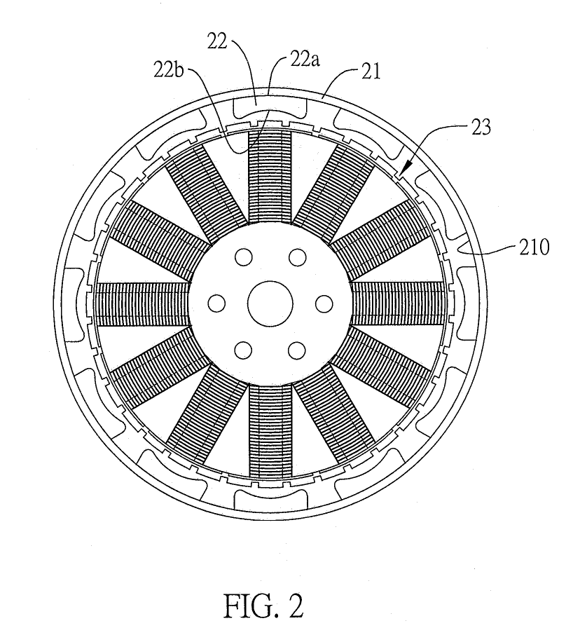

Please refer to FIG. 2, which is a planar view of a motor rotor and its corresponding stator of an embodiment according to the present invention.

As shown in the figure, the motor rotor of the embodiment according to the present invention comprises an annular body 21 having an inner lateral surface 210, and a plurality of magnetic bodies 22 installed on the inner lateral surface 210 of the annular body 21. Each of the magnetic bodies 22 has a first curved surface 22a and a second curved surface 22b opposing the first curved surface 22a. Each of the magnetic bodies 22 is fastened to the inner lateral surface 210 of the annular body 21 via the first curved surface 22a. The second curved surface 22b faces the stator 23, and the first curved surface 22a has a first curvature not equal to a second curvature of the second curved surface 22b. In the embodiment, the first curvature is preferably less than the second curvature. Note that the embodiment is exemplified with 12 magnetic bodies, while other embodiments may contain any number of magnetic bodies.

In the embodiment, the magnetic bodies 22 are selectively fastened, riveted or adhered to the inner lateral surface 210 of the annular body 21.

In the embodiment, the annular body 21 may be preferably a sheet metal part, non-magnetoconductive metal or plastic, and the non-magnetoconductive metal is one selected from the group consisting of aluminum, copper, zinc, tantalum and stainless steel, but is not limited thereto.

In the embodiment, the magnetic bodies 22 are permanent magnets.

In conclusion, since the first curvature of the first curved surface 22a is different from the second curvature of the second curved surface 22b; that is, each of the magnetic bodies 22 has an uneven thickness, an air gap between the motor rotor and a stator also has an uneven width, resulting in the decrease of cogging torques and the generation of a counter electromotive force that is close to a sine or cosine wave. Under a condition that the energy density of the magnetic bodies 22 is not reduced, the influence of the tolerance of the magnetic bodies 22 on the magnetic path may still be reduced. In addition, the motor rotor may reduce the noises generated by an operating motor effectively.

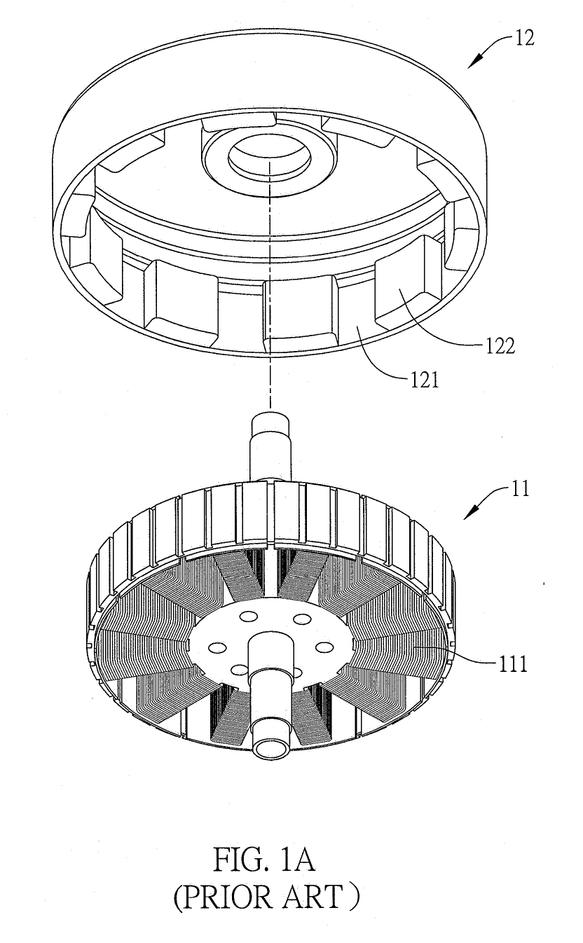

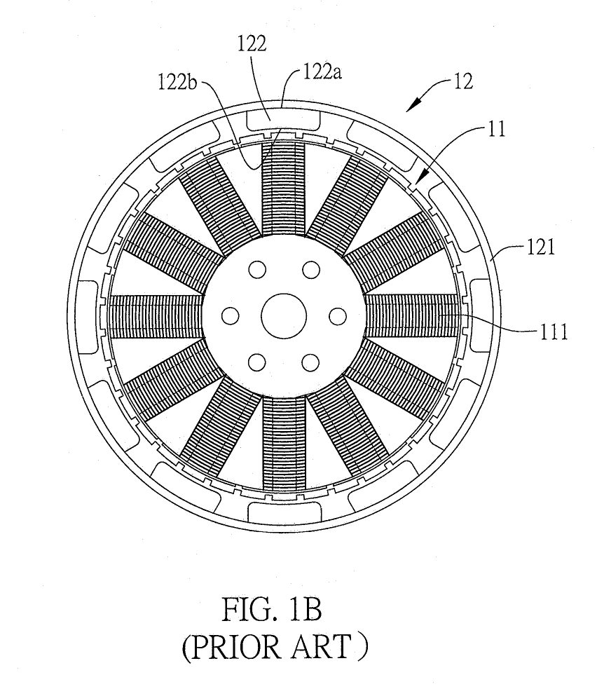

Note that the motor rotor of embodiments according to present invention may be applied to a variety of motors, such as, but not limited to, a brushless DC motor (BLDC motor), a permanent magnet synchronous motor (PMSM) or a ceiling fan motor. For example, the motor rotor of the present invention may be applied to the motor shown in FIGS. 1A and 1B. Accordingly, the motor of the present invention comprises the stator 11 and the motor rotor surrounding an outer periphery of the stator 11, wherein the motor rotor comprises the annular body 21 having an inner lateral surface 210, and the magnetic bodies 22 installed on the inner lateral surface 210 of the annular body 21.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A motor rotor, comprising:
an annular body having an inner lateral surface; and
a magnetic body installed on the inner lateral surface of the annular body, the magnetic body having a first curved surface with a first curvature fastened to the inner lateral surface of the annular body and a second curved surface with a second curvature opposing the first curved surface, wherein the second curvature is different to the first curvature.

2. The motor rotor of claim 1, wherein the first curvature is less than the second curvature.

3. The motor rotor of claim 1, wherein the magnetic body is fastened to the inner lateral surface of the annular body by a locking, a riveting or an adhering technique.

4. The motor rotor of claim 1, wherein the annular body is a sheet metal part.

5. The motor rotor of claim 1, wherein the annular body comprises non-magnetoconductive metal or plastic.

6. The motor rotor of claim 5, wherein the non-magnetoconductive metal is one selected from the group consisting of aluminum, copper, zinc, tantalum and stainless steel.

7. The motor rotor of claim 1, wherein the magnetic body is a permanent magnet.

8. A motor, comprising:
a stator; and
a motor rotor surrounding an outer periphery of the stator, and comprising an annular body having an inner lateral surface; and
a magnetic body installed on the inner lateral surface of the annular body, the magnetic body having a first curved surface with a first curvature fastened to the inner lateral surface of the annular body and a second curved surface with a second curvature opposing the first curved surface, wherein the second curvature is different to the first curvature.

9. The motor of claim 8, wherein the first curvature is less than the second curvature.

10. The motor of claim 8, wherein the magnetic body is fastened to the inner lateral surface of the annular body by a locking, a riveting or an adhering technique.

11. The motor of claim 8, wherein the annular body is a sheet metal part.

12. The motor of claim 8, wherein the annular body comprises non-magnetoconductive metal or plastic.

13. The motor of claim 12, wherein the non-magnetoconductive metal is one selected from the group consisting of aluminum, copper, zinc, tantalum and stainless steel.

14. The motor of claim 8, wherein the magnetic body is a permanent magnet.
